(19) United States
(12) Patent Application Publication
(10) Pub. No.: US 2010/0216517 A1
(43) Pub. Date: Aug. 26, 2010

(54) METHOD FOR RECOGNIZING MOTION BASED ON MOTION SENSOR AND MOBILE TERMINAL USING THE SAME

(75) Inventors: Woo Jin JUNG, Gyeonggi-do (KR); Hyun Su HONG, Gyeonggi-do (KR); Sun Young PARK, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/707,695

(22) Filed: Feb. 18, 2010

(30) Foreign Application Priority Data
Feb. 24, 2009 (KR) 10-2009-0015300

(51) Int. Cl. H04B 1/38; G06F 3/041

(52) U.S. Cl. 455/566; 345/173

(57) ABSTRACT

A method for recognizing motion based on a motion sensor and a mobile terminal using the same are provided. The method includes determining an input type of the user's motion; compensating output data of the input user's motion using a compensated parameter value set corresponding to the determined input type of the user's motion; and recognizing the input user's motion by the compensated output data. The mobile terminal can uniformly recognize the user's motion regardless of the position of the mobile terminal in which a tapping motion is input and the direction in which a snapping motion is input, and thus the motion recognition rate of the mobile terminal is significantly improved.

### CLAIM OF PRIORITY

This application claims the benefit of an earlier Korean Patent Application No. 10-2009-0015300 filed in the Korean Intellectual Property Office on Feb. 24, 2009, the entire contents of which are incorporated herein by reference.

### BACKGROUND OF THE INVENTION

1. Field of the Invention

The present invention relates to a method for recognizing motion based via a motion sensor in a mobile terminal. More particularly, the present invention relates to a method of recognizing user's motion by applying a compensated parameter and a mobile terminal using the same.

2. Description of the Related Art

A mobile terminal has become a must in modern life. With an increase in popularity of mobile terminals, a user interface technology related to a method of controlling a mobile terminal has been continuously grown.

While a conventional user interface has been made through a keypad provided in a mobile terminal, a user interface technology using a touch sensor or a tactile sensor has been introduced. In a portable terminal provided with a motion sensor, if a user applies a motion to the mobile terminal, the mobile terminal recognizes the user's motion and performs a corresponding function.

In general, if a user inputs a motion of tapping a mobile terminal several times with the same strength, a motion sensor senses it as tapping motions with the same strength. However, if a user changes an input position while the user is inputting the tapping motions with the same strength, the motion sensor may sense the motions to be different input strength.

In the case of a conventional mobile terminal provided with a motion sensor, the input strength of a tapping motion, which is sensed by the motion sensor, has been used. The minimum motion strength or the maximum motion strength has been set, and the mobile terminal recognizes only a user's motion with strength higher than the minimum motion strength or lower than the maximum motion strength to perform the corresponding function. However, in the case in which the motion sensor senses the input strength differently in accordance with positions in which the motion is input, the motion sensor may sense the input motion with a strength that is below the minimum motion strength depending upon the input position even when the user intended to input a tapping motion higher than the minimum motion strength. In this case, the mobile terminal is unable to sense the user's motion correctly, thus a user must input the motion again repeatedly or with a higher strength which causes inconveniences.

Also in a snapping motion, even if the user inputs the snapping motion to the mobile terminal with the same input strength, the motion sensor may sense the snapping motion with a different input strength depending upon the snapping direction. If the input strength of the snapping motion does not satisfy a predetermined condition, the mobile terminal may not recognize the snapping motion.

Accordingly, there is a need for an improved way of recognizing a user's motion more accurately in a mobile terminal.

### SUMMARY OF THE INVENTION

The present invention has been made in view of the above problems and provides additional advantages, by providing a method that can uniformly recognize a user's motion regardless of the position of a mobile terminal in which a tapping motion is input.

The present invention also provides a method that can uniformly recognize a user's motion regardless of the direction in which a snapping motion is input.

The present invention also provides a mobile terminal that uses the above-described method.

In accordance with an aspect of the present invention, a method for recognizing the motion for a mobile terminal having a motion sensor includes: if at least one user's motion is input, determining an input type of the user's motion; compensating output data of the input user's motion using a compensated parameter value set corresponding to the determined input type of the user's motion; and recognizing the input user's motion by the compensated output data.

In an embodiment of the invention, determining the input type determines the position of the mobile terminal in which the user's motion is input.

In an embodiment of the invention, determining the input type determines an input direction of the user's motion.

The method for recognizing motion according to an embodiment of the invention may further include setting the compensated parameter value corresponding to the input type of the user's motion.

In accordance with another embodiment, a method of recognizing a user's motion in a mobile terminal having a motion sensor, includes determining an input type of the user's motion in a specific position of the mobile terminal; extracting a compensated parameter value corresponding to the determined input type of the user's motion from a predetermined compensated database; generating a compensated input strength using the extracted compensated parameter value; and recognizing the input user's motion using the compensated input strength. The predetermined compensated database is obtained by: displaying at least one user input required in the mobile terminal; sensing the at least one user input; measuring an input strength for a preset number of times; and determining the compensated parameter value by computing an average value of the at least one user input repeated in a predetermined position of the mobile terminal.

In accordance with another aspect of the present invention, a mobile terminal for motion recognition includes: a sensor unit sensing an input of a user's motion; a data analysis unit analyzing at least one data of a position of the mobile terminal in which the user's motion is input, an input direction, and an input strength; a compensation unit compensating the input strength of the user's motion using a compensated parameter value set corresponding to the analyzed position of the mobile terminal or the input direction; and a motion recognition unit recognizing the input user's motion with the compensated input strength.

The mobile terminal for motion recognition according to an embodiment of the invention may further include a compensated parameter value setting unit calculating the compensated parameter value based on at least one data received from the data analysis unit and setting the calculated compensated parameter value corresponding to the position of the corresponding mobile terminal or the input direction

The mobile terminal can uniformly recognize the user's motion regardless of the position of the mobile terminal in which a tapping motion is input and the direction in which a snapping motion is input, and thus the motion recognition rate of the mobile terminal can be improved.

### BRIEF DESCRIPTION OF THE DRAWINGS

The above features and advantages of the present invention will be more apparent to those skilled in the art from the following detailed description in conjunction with the accompanying drawings, in which:

FIG. 1 is a block diagram illustrating a configuration of a mobile terminal 100 for motion recognition according to an exemplary embodiment of the present invention;

FIG. 2 is a block diagram illustrating a configuration of a control unit 170 according to an exemplary embodiment of the present invention;

FIG. 3 is a flowchart illustrating a process of determining a compensated parameter value according to an exemplary embodiment of the present invention;

FIG. 4 is a flowchart illustrating a process of applying a compensated parameter value according to an exemplary embodiment of the present invention;

FIG. 5A is a view illustrating a display screen for guiding an input of a tapping motion according to an exemplary embodiment of the present invention;

FIG. 5B is an exemplary view explaining positions in which an input of a tapping motion is required in a mobile terminal according to an exemplary embodiment of the present invention;

FIG. 6A is a view illustrating a display screen for guiding an input of a snapping motion according to an exemplary embodiment of the present invention;

FIG. 6B is an exemplary view explaining directions in which an input of a snapping motion is required in a mobile terminal according to an exemplary embodiment of the present invention;

FIG. 7 is a view explaining a three-dimensional axis based on a motion sensor according to an exemplary embodiment of the present invention;

FIG. 8 is a view explaining acceleration data against a specified axis of a mobile terminal that is related to a tapping operation according to an exemplary view of the present invention; and

FIG. 9 is a view explaining acceleration data against a specified axis of a mobile terminal that is related to a snapping operation according to an exemplary view of the present invention.

### DETAILED DESCRIPTION OF THE INVENTION

Hereinafter, exemplary embodiments of the present invention are described in detail with reference to the accompanying drawings. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

In the following description, although a mobile terminal is exemplified, the present invention is not limited thereto. That is, a mobile terminal according to the present exemplary embodiment may be a terminal provided with a motion sensor, and may include all information communication appliances and multimedia appliances, such as a mobile communication terminal, a portable multimedia player (PMP), a personal digital assistant (PDA), a smart phone, an MP3 player, or the like.

In an exemplary embodiment of the present invention, explanation will be made around tapping and snapping among user's motions that can be recognized by a mobile terminal. However, the invention is not limited thereto and the teachings of the present invention can be applied to other motions (e.g. shaking, tilting, or the like) recognized by a mobile terminal having a motion sensor.

Also, in an exemplary embodiment of the present invention, explanation will be made around motion input strength among parameters that can be considered in tapping and snapping motions. However, the invention is not limited thereto, and parameters (e.g. motion recognition time, motion time interval, or the like) other than the motion input strength can be applied to the present invention.

FIG. 1 is a block diagram illustrating a configuration of a mobile terminal 100 for motion recognition according to an exemplary embodiment of the present invention.

In operation, a wireless communication unit 110 performs transmission/reception of data for wireless communication. The wireless communication unit 110 includes an RF transmitter up-converting and amplifying the frequency of a transmitted signal, an RF receiver low-noise-amplifying and down-converting a frequency of a received signal, and the like. Also, the wireless communication unit 110 receives data via a wireless channel to output the received data to a control unit 170, and transmits data output from the control unit 170 through the wireless channel.

A motion sensor 120 serves to receive an input of a motion that a user typically performs with respect to the mobile terminal 100. Note that an ultrasonic sensor, an acceleration sensor, a camera sensor, a gyro sensor, or other sensors known to artisians may be used. If a user's motion is input to the mobile terminal 100, the motion sensor 120 according to an embodiment of the present invention generates acceleration data related to the input user's motion and transmits the acceleration data to the control unit 170.

An audio processing unit 130 may be a codec, which may include a data codec that processes packet data and an audio codec that processes an audio signal. The audio processing unit 130 converts a digital audio signal into an analog audio signal through the audio codec to output the analog audio signal to a speaker SPK, and converts an analog audio signal input from a microphone MIC into a digital audio signal through the audio codec.

A storage unit 140 serves to store therein programs required for operation of the mobile terminal 100 and data, and may be divided into a program region and a data region.

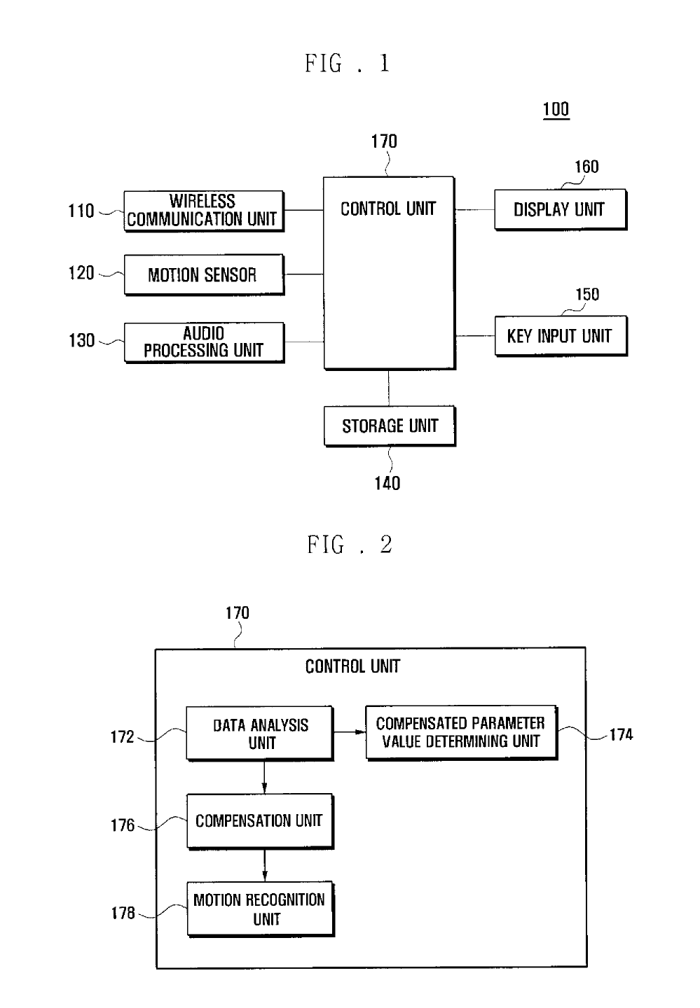

Referring to FIG. 2, the storage unit 140 according to an embodiment of the present invention also stores “compensated parameter values” determined by a compensated parameter value determining unit 174. The “compensated parameter value” represents a data value that is used to change an input strength value, which is acquired by a data analysis unit 172 through analysis of the acceleration data, to a strength value that a motion recognition unit 178 uses in recognizing the user's motion.

Referring back to FIG. 1, a key input unit 150 receives a user's key manipulation signal for controlling the mobile terminal 100 and transfers the received key manipulation signal to the controller 170. The key input unit 150 may be a keypad that includes numeral keys and direction keys. In the case of a touch screen based mobile terminal 100, a touch pad may be adopted as the key input unit 150.

A display unit 160 may be formed of a liquid crystal display (LCD) or an organic light emitting diode (OLEO), and visually provide a menu of the mobile terminal 100, input data, function setting information, and other various information to a user. For example, the display unit 160 serves to output a booting screen of the mobile terminal 100, a standby screen, a display screen, a call screen, and other application execution screens. The display unit 160 according to an embodiment of the present invention can display a user's motion of which an input is required when setting the compensated parameter value. The user may input a motion to the mobile terminal 100 in accordance with the motion displayed on the display unit 160.

The control unit 170 controls the whole operation of the mobile terminal 100. FIG. 2 shows a configuration of the control unit 170 according to an exemplary embodiment of the present invention. The control unit 170 includes a data analysis unit 172, a compensated parameter value determining unit 174, a compensation unit 176, and a motion recognition unit 178.

The data analysis unit 172 serves to determine the position of the mobile terminal 100 to which a user's motion is input, the input direction, and the input strength by analyzing acceleration data received from the motion sensor 120.

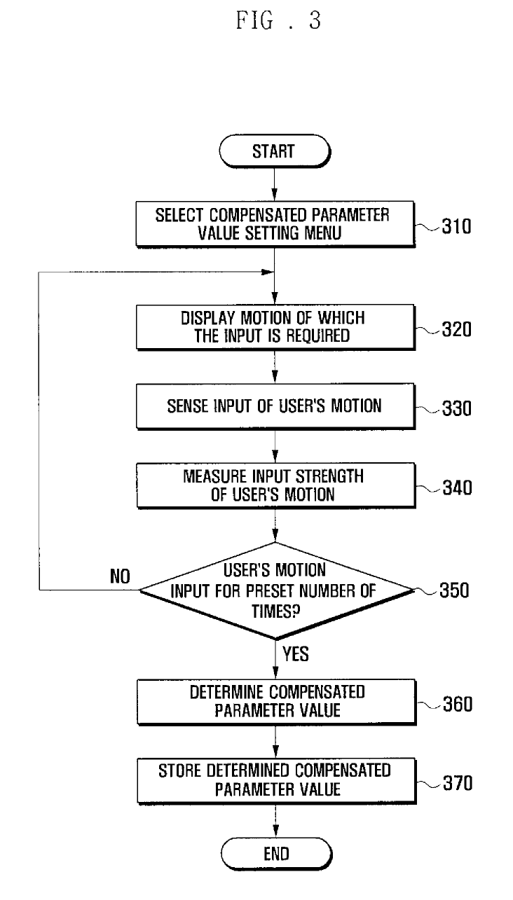

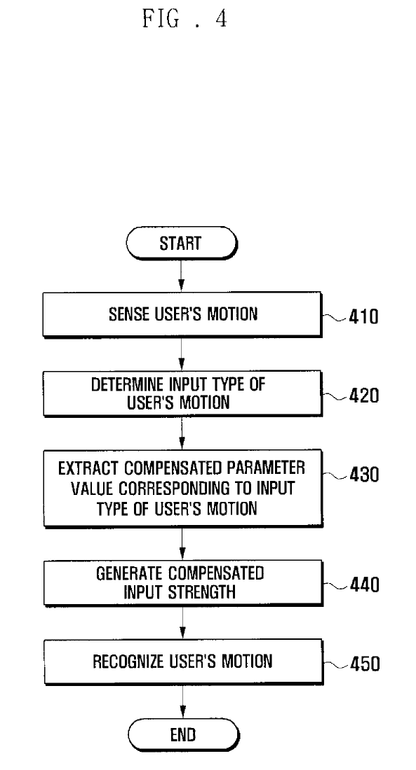

The compensated parameter value determining unit 174 serves to determine the compensated parameter value using the position of the mobile terminal 100 corresponding to a user's motion that is predetermined by the data analysis unit 172 based on user's input, the input direction, and the input strength on various position on the mobile terminal. A detail description of determining the compensated parameter value is explained later with reference to FIG. 3.

Briefly, in the case of a tapping motion, a position that is the basis for determining the compensated parameter value has been set in the mobile terminal 100, and the compensated parameter value determining unit 174 determines a compensated parameter value corresponding to each position of the mobile terminal 100, by comparing the strength of the tapping motion input in the position that is the basis for determining the compensated parameter value with the strength of the tapping motion input in a position other than the position that is the basis as described above.

In the case of a snapping motion, a direction that is the basis for determining the compensated parameter value has been set in the mobile terminal 100, and the compensated parameter value determining unit 174 determines a compensated parameter value corresponding to each direction of the mobile terminal 100, by comparing the input strength of the snapping motion input in the direction that is the basis for determining the compensated parameter value with the input strength of the snapping motion input in a direction other than the direction that is the basis for determining the compensated parameter value.

In the embodiment of the present invention, the compensated parameter value may be in the form of a counted value for increasing or decreasing the input strength at a predetermined rate, or may be in the form of an input strength value for adding or subtracting the input strength itself. For example, in the case of the tapping motion, if it is assumed that the strength of the tapping motion input in the position that is the basis for determining the compensated parameter value is 1 g and the strength of the tapping motion input in another position is 0.5 g, the compensated parameter value may be set to “2(1 g/0.5 g)” that is in the form of a coefficient value, or may be set to“+0.5 g (1 g−0.5 g)” that is in the form of an input strength value. This value is stored in the storage unit 140.

The compensation unit 176 compensates the strength value of the input user's motion using the compensated parameter value stored in the storage unit 140. Specifically, the compensation unit 176 receives from the data analysis unit 172 data of input position of the mobile terminal 100 or input direction, and the input strength, extracts the compensated parameter value that corresponds to input position or the input direction from the storage unit 140, then generates a compensated input strength by applying the extracted compensated parameter value to the input strength of the user's motion. The compensation unit 176 transfers the compensated input strength to the motion recognition unit.

The motion recognition unit 178 serves to recognize the user's motion using the input strength of the user's motion received from the data analysis unit 172 or the compensated input strength of the user's motion received from the compensation unit 176. In the mobile terminal 100, the minimum motion strength and the maximum motion strength have been set, and the motion recognition unit 178 compares the input strength of the user's motion received from the data analysis unit 172 or the compensation unit 176 with the minimum motion strength or the maximum motion strength and recognizes the user's motion having the strength that is higher than the minimum motion strength and lower than the maximum motion strength.

FIG. 3 is a flowchart illustrating a process of determining a compensated parameter value according to an exemplary embodiment of the present invention.

If the user selects a menu for setting a compensated parameter value, the control unit 170 executes a compensated parameter value setting menu application in step 310. The compensated parameter value setting menu may be included in a main menu of the mobile terminal 100 as a lower-level menu of the user's setting menu.

The control unit 170 controls the display unit 160 to display the motion of which the input is required in step 320. In relation to the tapping motion, the control unit 170 displays a display screen related to the input position of the tapping motion on the display unit 160 to guide the user's input the tapping motion, and the user inputs the tapping motion according to the screen displayed on the display unit 160. In relation to the snapping motion, the control unit 170 displays a display screen related to the input direction of the snapping motion, and the user inputs the snapping motion according to the screen displayed on the display unit 160.

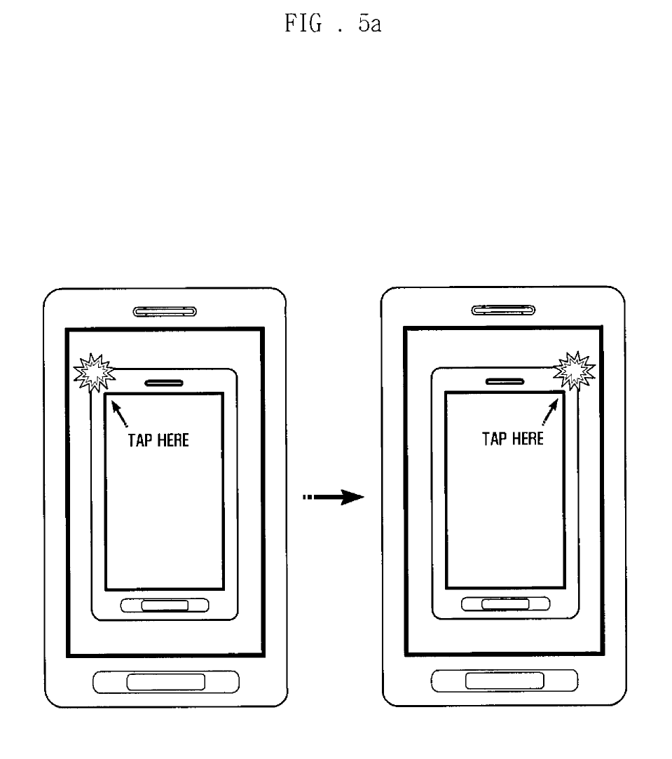

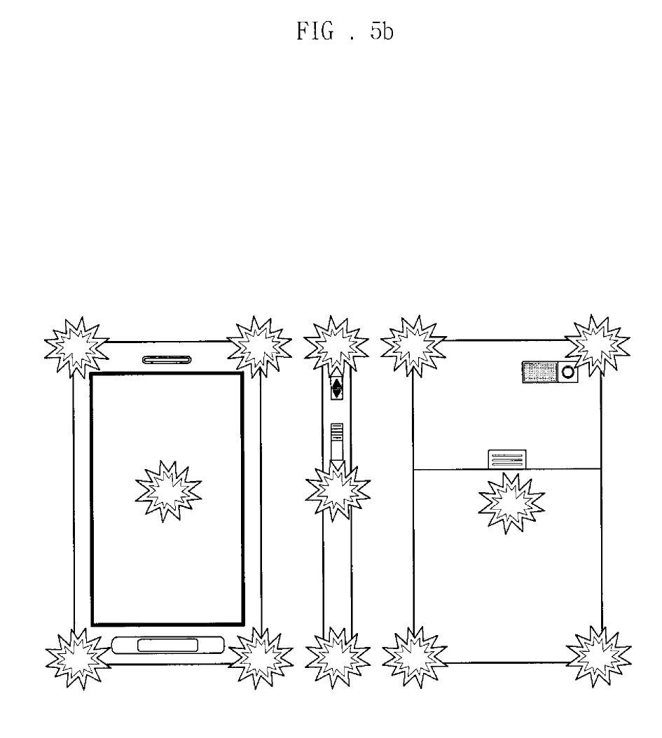

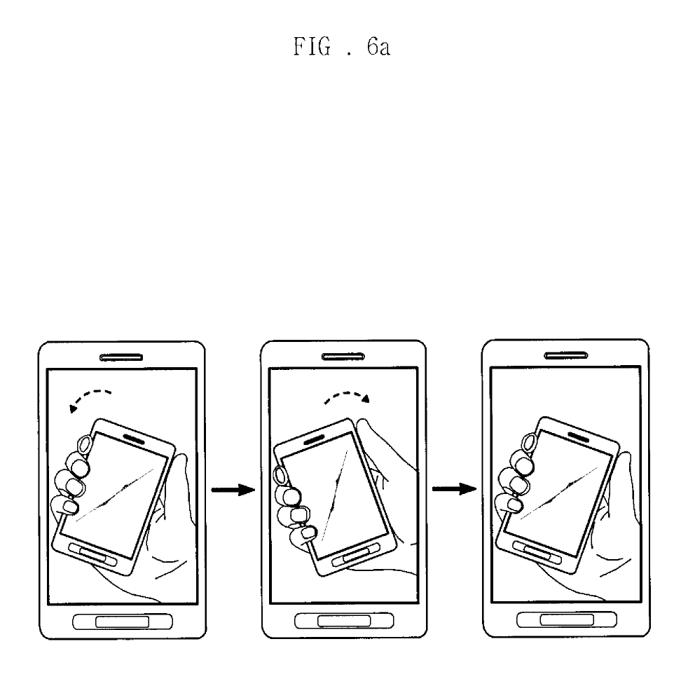

FIG. 5A is a view illustrating a display screen for guiding an input of a tapping motion according to an exemplary embodiment of the present invention. The control unit 170 controls the display unit 160 to display the main body of the mobile terminal 100 and the input position of the tapping motion. In the embodiment of the present invention, the control unit 170 may also display an expression “Tap here” on the display unit 160. Similarly, FIG. 5B is an exemplary view explaining positions in which an input of a tapping motion is required in a mobile terminal 100 according to an exemplary embodiment of the present invention. In the embodiment of the present invention, positions in which the compensated parameter values are set have been determined in the mobile terminal 100. The control unit 170 controls the display unit 160 to display graphics or a message that requires the tapping motion input in the positions in which the compensated parameter values are to be set. The first figure in FIG. 5B shows a front surface of the mobile terminal 100, and tapping motion input signs are displayed at upper left, upper right, lower left, lower right, and center parts thereof. The second figure in FIG. 5B shows a side surface of the mobile terminal 100, and tapping motion input signs are displayed at the upper end, center, and lower end parts thereof. The third figure in FIG. 5B shows a rear surface of the mobile terminal 100, and tapping motion input signs are displayed at upper left, upper right, lower left, lower right, and center parts thereof.

If the tapping motion input positions required to set the compensated parameter value are set as shown in FIG. 5B, the control unit 170 controls the display unit 160 to sequentially display the motion input positions as shown in FIG. 5B to guide the user's input of tapping motion.

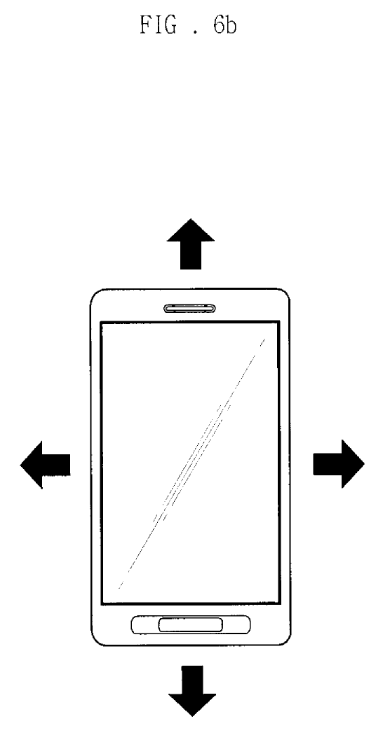

FIG. 6A is a view illustrating a display screen for guiding an input of a snapping motion according to an exemplary embodiment of the present invention. The control unit 170 controls the display unit 160 to display the main body of the mobile terminal 100, a hand that holds the mobile terminal 100, and an input motion. FIG. 6B is an exemplary view explaining directions in which an input of a snapping motion is required in a mobile terminal 100 according to an exemplary embodiment of the present invention. In the embodiment of the present invention, input directions in which the compensated parameter values are set have been determined in the mobile terminal 100. The control unit 170 controls the display unit 160 to display snapping motion in input directions in which the compensated parameters are to be set. In FIG. 6B, four input directions of upward, downward, left, and right are shown. The control unit 170 controls the display unit 160 to sequentially display the snapping motions in upward, downward, left, and right directions.

In the embodiment of the present invention, the control unit 170 may control the display unit 160 to display a message for requesting a user to repeatedly input the tapping motion in the same position. For example, in the case of the tapping motion, the control unit 170 may control the display unit 160 to display a message indicating “Tap here five times” in a specified position of the mobile terminal 100, or to display a message indicating “Tap here” five times. In the case of the snapping motion, the control unit 170 may control the display unit 160 to display the same input motion successively five times, or to display a message indicating “Repeat five times.”

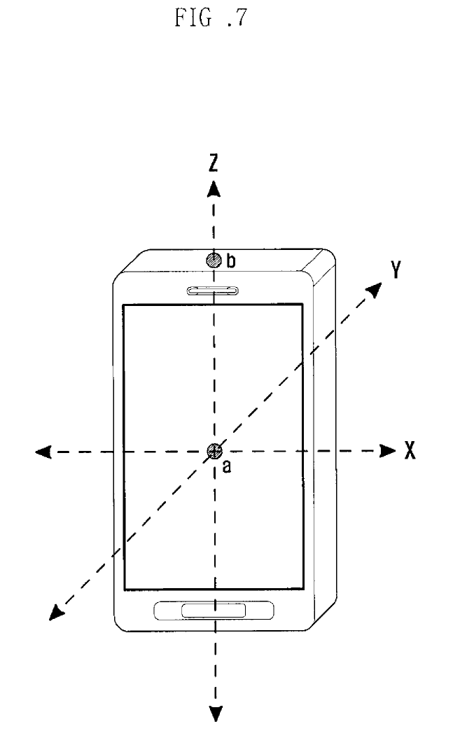

If the user inputs the motion to the mobile terminal 100 according to the contents displayed on the display unit 160, the motion sensor 120 senses the user's motion input in step 330. The motion sensor 120 generates acceleration data related to the input user's motion, and transfers the acceleration data to the control unit 170. In the embodiment of the present invention, the acceleration data represents output data against a fixed axis around the motion sensor 120. FIG. 7 is a view explaining a three-dimensional axis based on a motion sensor 120 according to an exemplary embodiment of the present invention. The motion sensor 120 may be formed in any position of the mobile terminal 100. In the present invention, it is assumed that the motion sensor 120 is formed to be positioned in the center part of the mobile terminal 100. In FIG. 7, X, Y, and Z axes are illustrated around the center part of the mobile terminal 100. If the user inputs a motion to the mobile terminal 100, the motion sensor 120 generates the acceleration data about X, Y, and Z axes and transmits the generated acceleration data to the control unit 170. In accordance with the user's motion input type, the acceleration data on the X, Y, and Z axes may differ. For example, if the user inputs a tapping motion in the center part (i.e. “a” point) on the front surface of the mobile terminal 100, the acceleration change on the Y axis greatly occurs, but the acceleration change on the X or Z axis hardly occurs. Also, if the user inputs a tapping motion in the upper end part (i.e. “b” point) of the mobile terminal 100, the acceleration change on the Z axis greatly occurs, but the acceleration change on the X or Y axis hardly occurs. In the case of a snapping motion, if the user inputs a snapping motion on the left side, the acceleration change on the X axis greatly occurs, and as the mobile terminal 100 is tilted in the side direction, the acceleration change on the Z axis somewhat occurs, but the acceleration change on the Y axis hardly occurs.

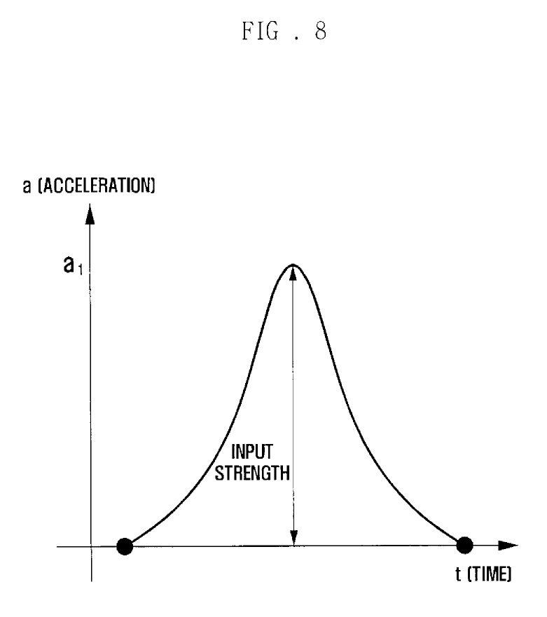

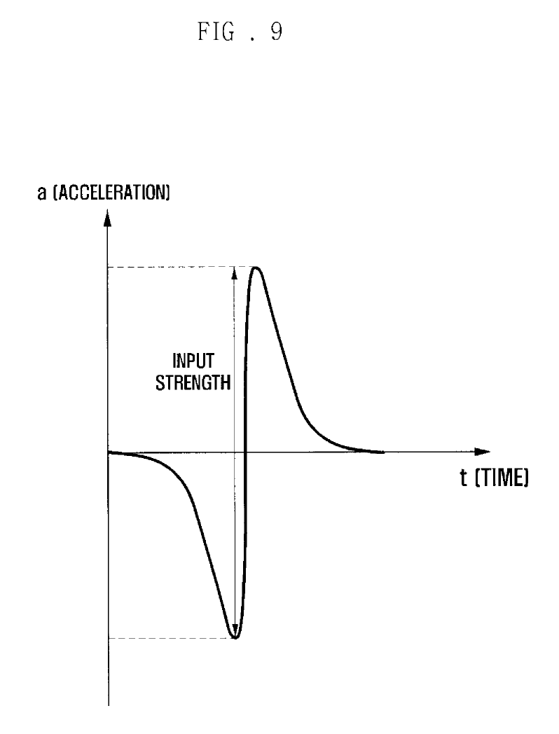

FIG. 8 is a view explaining acceleration data against a specified axis of a mobile terminal 100 that is related to a tapping operation according to an exemplary view of the present invention. In FIG. 8, a graph in which the x axis represents time and the y axis represents acceleration is illustrated. FIG. 8 may also correspond to a graph of acceleration data on the Y axis in FIG. 7 when the user inputs a tapping motion in the center part (i.e. “a” point) of the mobile terminal 100. FIG. 9 is a view explaining acceleration data against a specified axis of a mobile terminal 100 that is related to a snapping operation according to an exemplary view of the present invention. FIG. 9 may also correspond to a graph of acceleration data on the X axis in FIG. 7 when the user inputs a snapping motion in the left direction.

The data analysis unit 172 determines the input strength of the user's motion by analyzing the acceleration data in step 340. In the case of a tapping operation, the data analysis unit 172 determines the input position of the user's motion by analyzing the acceleration data in step 340. The data analysis unit 172 can judge whether the user has accurately inputted the tapping motion in the position displayed on the display unit 160 by judging the input position of the tapping motion. For example, if the user has inputted the tapping motion at point “b” in a state in which the control unit 170 controls the display unit 160 to display a message to input the tapping motion at point “a”, the data analysis unit 172 judges that the tapping motion has not been inputted at point “a” by analyzing the acceleration data received from the motion sensor 120. If the user has accurately inputted the tapping motion at point “a,” the data analysis unit 172 judges the input strength of the tapping motion. Referring to FIG. 8, “a1” corresponds to the maximum acceleration size, and this is in proportion to the input strength of the user's motion. The data analysis unit 172 judges the user's input strength using a1.

In the case of the snapping motions, the data analysis unit 172 judges the input direction of the user's motion by analyzing the acceleration data in step 340. The data analysis unit can judge whether the user has accurately inputted the snapping motion in the motion direction displayed on the display unit 160 by judging the input direction of the snapping motion. If the user has inputted the snapping motion in the accurate direction, the data analysis unit 172 judges the input strength of the snapping motion. In the graph illustrated in FIG. 9, the difference value between the maximum acceleration and the minimum acceleration is in proportion to the input strength of the user's motion. The data analysis unit 172 judges the user's input strength using the above-described difference value.

In the embodiment that requires a repeated input of tapping motion in the specified position of the mobile terminal 100, the data analysis unit 172 judges the input strengths of the user's motion by analyzing the acceleration data received from the motion sensor 120, and calculates an average value of the judged in put strengths of the user's motions. The data analysis unit 172 transmits the calculated average value to the compensated parameter value determining unit 174.

In order to determine the compensated parameter value, the input strength of the user's motion is required. In the case of determining the compensated parameter value using the input strength judged from the one motion input, the input characteristic of the user's motion may not be accurately reflected in the compensated parameter value. Accordingly, more accurate compensated parameter value can be derived through processes of receiving repeated tapping motions in the same position, judging the input strengths from the input tapping motions, calculating an average value of the judged input strengths, and determining the compensated parameter value using the calculated average value.

In the embodiment of the present invention, the data analysis unit 172 judges the input strengths of the user's motions by analyzing the acceleration data received from the motion sensor 120, extracts the minimum value among the input strengths of the judged user's motions, and transmits the extracted minimum value to the compensated parameter value determining unit 174. The transmitted minimum value of the input strength is used for the compensated parameter value determining unit 174 to determine the compensated parameter value.

In the case of the snapping motions, if the snapping motions in the same direction is repeatedly input from the user, the data analysis unit 172 judges the input strengths of the snapping motions, calculates the average value of the input strengths or extracts the minimum value, and then transmits the average value or the minimum value to the compensated parameter value determining unit 174.

In step 350 of FIG. 3, the control unit 170 judges whether the user's motion has been inputted to the mobile terminal 100 for a predetermined number of times. During the tapping motion, if the positions in which the compensated parameter values are set as shown in FIG. 5B are determined as the upper left, upper right, lower left, lower right, and center portions of the front and rear surfaces of the mobile terminal 100 and the upper end, center, and lower end portions of both side surfaces of the mobile terminal 100, the control unit 170 controls the display unit 160 to display 16 tapping motions in total, and the user inputs 16 tapping motions to the mobile terminal 100. If the repeated input of the tapping motion is required for the respective set positions, the user inputs the tapping motions to the mobile terminal as many as the number obtained by multiplying the set number of input positions by the number of repetitions of the tapping motions. For example, as shown in FIG. 5B, if the number of input positions set in the mobile terminal 100 is set to 16 and the number of motion repetitions is set to 5, the user inputs 80 (16*5) tapping motions to the mobile terminal 100 in total.

Even in the case of the snapping motions, as shown in FIG. 6B, if the number of motion directions is set to 4 and the number of motion repetitions is set to 5, the user inputs 20 (4*5) snapping motions to the mobile terminal 100 in total.

If the user inputs the motions to the mobile terminal 100 for a predetermined number of times, the compensated parameter value determining unit 174 determines the compensated parameter values corresponding to the respective motion input positions or direction in step 360. In the mobile terminal 100, the position that is the basis for determining the compensated parameter values is set among the positions in which the tapping motions are input, and the compensated parameter value determining unit 174 determines the compensated parameter values based on the strength of the motions input in the position that is the basis for determining the compensated parameter values.

Referring to FIGS. 5B and 7, in the portable terminal 100, the number of positions in which the tapping motions are input is set to 16 in total. Here, it is assumed that the point “a” is set as the position that is basis for determining the compensated parameter values. The data analysis unit 172 judges that the input strength at point “a” is 1 g and the input strength at point “b” is 0.5 g by analyzing the acceleration data. The compensated parameter value determining unit 174 compares the input strength (e.g. 1 g) at point “a” with the input strength (e.g. 0.5 g) at point “b”, and judges that the input strength at point “b” is 112 of the input strength at point “a” to determine that the compensated parameter value at point “b” is “2”. In the same manner, if it is judged that the input strength in another position is 0.25 g, the compensated parameter value determining unit 174 determines the compensated parameter value at that point is “4”. In the embodiment of the present invention, the compensated parameter value determining unit 174 may determines the compensated parameter value in the form of an input strength value. For example, if it is judged that the input strength at point “a” is 1 g and the input strength at point “b” is 0.5 g by analyzing the acceleration data, the compensated parameter value determining unit 174 compares the input strength (e.g. 1 g) at point “a” with the input strength (e.g. 0.5 g) at point “b”, and judges that the input strength at point “b” is smaller than the input strength at point “a” by 0.5 g to determine the compensated parameter value at point “b” as “−0.5 g”.

Even in the case of the snapping motions, the direction that is the basis for determining the compensated parameter values has been set. If the direction that is the basis is set to the right direction, the compensated parameter value determining unit 174 determines the compensated parameter value by comparing the input strength in the right direction and the input strength in another direction.

In step 370, the control unit 170 makes the determined compensated parameter values correspond to the corresponding positions or directions and stores the obtained values in the storage unit 140. Referring to FIG. 5B, the control unit 170 makes the compensated parameter values corresponding to 16 places of the mobile terminal 100 match the respective positions and stores the resultant values in the storage unit 140. Referring to FIG. 6B, the control unit 170 makes the compensated parameter values corresponding to four directions match the respective directions and stores the resultant values in the storage unit 140.

FIG. 4 is a flowchart illustrating a process of applying a compensated parameter value according to an exemplary embodiment of the present invention.

If the user inputs motions to the mobile terminal 100, the motion sensor 120 senses the input of the user's motions in step 410, generates and transmits the corresponding acceleration data to the control unit 170. The data analysis unit 172 in the control unit 170 receives the acceleration data from the motion sensor 120 and judges the user's motion input type. In the case of the tapping motions, the data analysis unit 172, referring to FIG. 7, judges the position in which the tapping motions are input by analyzing the acceleration data on X, Y, and Z axes. The data analysis unit 172 judges the input strength of the user's tapping motions by analyzing the acceleration data. The data analysis unit 172 transmits information about the input positions and input strengths of the tapping motions to the compensation unit 176. In the case of the snapping motions, the data analysis unit 172 judges the input directions and the input strengths of the snapping motions by analyzing the acceleration data, and transmits the judged information to the compensation unit 176.

In step 430, the compensation unit 176 extracts the compensated parameter values set corresponding to the user's input types among the compensated parameter values stored in the storage unit 140. In the case of the tapping motions, the compensation unit 176 is extracts the compensated parameter values set corresponding to the position of the mobile terminal 100 to which the user's motions are input. In the case of the snapping motions, the compensation unit 176 extracts the compensated parameter values set corresponding to the input directions of the user's motions. In step 440, the compensation unit 176 generates the compensated input strength by applying the compensated parameter value extracted from the storage unit 140 to the motion input strength received from the data analysis unit 172. For example, if the compensated parameter value is 4, and the motion input strength corresponds to 1 g, the compensation unit 176 generates the compensated input strength of 4*1 g=4 g. In another embodiment, if the compensated parameter value is +2 g, and the motion input strength corresponds to 1 g, the compensation unit 176 generates the compensated input strength of 1 g+2 g=3 g. The compensation unit 176 transmits the generated compensated input strength to the motion recognition unit 178.

The motion recognition unit 178 recognizes the user's motion using the compensated input strength received from the compensation unit 176 in step 450. In the mobile terminal 100, the minimum input strength or the maximum input strength by which the user's motion can be recognized has been set, and it is assumed that the motion recognition unit 178 can recognize only the user's motion having the strength that is higher than the minimum input strength or lower than the maximum input strength. The motion recognition unit 178 judges whether the compensated input strength received from the compensation unit 176 is higher than the minimum input strength or lower than the maximum input strength, and recognizes the user's motion when the set condition is satisfied. The control unit 170 performs the corresponding function based on the recognized user's motion.

In the invention, even if the input strength derived from the acceleration data is lower than the minimum input strength or is higher than the maximum input strength, the compensation unit 176 compensates the derived input strength so that the input strength is higher than the minimum input strength or is lower than the maximum input strength. The motion recognition unit 178 performs the motion recognition process with a compensated input strength, and thus the motion recognition rate can be improved.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A method for recognizing a user's motion in a mobile terminal having a motion sensor, comprising:
determining an input type of the user's motion,
compensating output data of the input user's motion using a compensated parameter value corresponding to the determined input type of the user's motion; and
recognizing the input user's motion using the compensated output data.

2. The method of claim 1, wherein determining the input type comprises determining position of the mobile terminal in which the user's motion is input.

3. The method of claim 1, wherein determining the input type comprises determining an input direction of the user's motion.

4. The method of claim 1, further comprising setting the compensated parameter value corresponding to the input type of the user's motion.

5. The method of claim 4, wherein setting the compensated parameter value comprises:
displaying at least one user input required;
extracting output data corresponding to the at least user input; and
determining the compensated parameter value based on the extracted output data.

6. The method of claim 5, wherein extracting the output data comprises computing an average value of the at least one user input repeated in a predetermined position of the mobile terminal.

7. The method of claim 5, wherein determining the compensated parameter value comprises comparing output data of the user's motion input in a first position that is the basis set in the mobile terminal with output data of the user's motion input in a second position that is other position than the first position.

8. The method of claim 5, wherein determining the predetermined compensated parameter value comprises comparing output data of the user's motion input in a first direction that is the basis set in the mobile terminal with output data of the user's motion input in a second direction that is other direction than the first direction.

9. The method of claim 1, wherein the output data corresponds to an input strength of the user's motion.

10. A mobile terminal for motion recognition, comprising:
a sensor unit sensing an input of a user's motion;
a data analysis unit analyzing at least one data of an input position, an input direction and an input strength of the user's motion;
a compensation unit compensating the input strength of the user's motion using a compensated parameter value set corresponding to the analyzed input position of the mobile terminal or the input direction; and
a motion recognition unit recognizing the input of the user's motion by applying the compensated input strength.

11. The mobile terminal of claim 10, further comprising a compensated parameter value setting unit calculating the compensated parameter value based on at least one data received from the data analysis unit, and setting the calculated compensated parameter value corresponding to the position of the corresponding mobile terminal or the input direction.

12. A method for recognizing a user's motion in a mobile terminal having a motion sensor, comprising:
determining an input type of the user's motion in a specific position of the mobile terminal;
extracting a compensated parameter value corresponding to the determined input type of the user's motion from a predetermined compensated database;
generating a compensated input strength using the extracted compensated parameter value; and
recognizing the input user's motion using the compensated input strength.

13. The method of claim 12, wherein determining the input type comprises determining an input direction of the user's motion.

14. The method of claim 12, wherein the predetermined compensated database is obtained by:
displaying at least one user input required in the mobile terminal;
sensing the at least one user input;
measuring an input strength for a preset number of times; and
determining the compensated parameter value by computing an average value of the at least one user input repeated in a predetermined position of the mobile terminal.

15. The method of claim 14, further comprising storing the determined compensated parameter value in the predetermined compensated database.
